(19) United States
(12) Patent Application Publication
(10) Pub. No.: US 2024/0384080 A1
(43) Pub. Date: Nov. 21, 2024

(54) PROPYLENE POLYMER COMPOSITION

(71) Applicant: Basell Poliolefine Italia S.r.l., Milano (IT)

(72) Inventors: Davide Tartari, Ferrara (IT); Stefano Spataro, Ferrara (IT); Alberto Nardin, Ferrara (IT); Lelio Basile, Ferrara (IT)

(73) Assignee: Basell Poliolefine Italia S.r.l., Milano (IT)

(21) Appl. No.: 18/693,834

(22) PCT Filed: Sep. 13, 2022
(86) PCT No.: PCT/EP2022/075428

§ 371 Date: Mar. 20, 2024

(30) Foreign Application Priority Data
Sep. 27, 2021 (EP) 21199211.0

(51) Int. Cl. C08L 23/12

(52) U.S. Cl. CPC C08L 23/12; C08L 2205/025

(57) ABSTRACT

A polypropylene composition made from or containing:
A) from 90.6 wt % to 97.0 wt % of a propylene homopolymer having a melt flow rate between 40.0 g/10 min and 100.0 g/10 min; and
B) from 3.0 wt % to 9.4 wt % of a propylene ethylene copolymer having an ethylene content ranging from 22 wt % to 38 wt %; wherein the polypropylene composition having:
i) a xylene soluble fraction at 25° C. ranging from 5 wt % to 13.0 wt %;
ii) the ethylene derived units content on the fraction insoluble in xylene at 25° C. ranging from 0.3 wt % to 1.6 wt %;
iii) the ethylene derived units content on the fraction soluble in xylene at 25° C. ranging from 13.2 wt % to 27.0 wt %; and
(iv) a melt flow rate, MFR between 35.0 g/10 min and 70.0 g/10 min.

### FIELD OF THE INVENTION

In general, the present disclosure relates to the field of chemistry. More specifically, the present disclosure relates to polymer chemistry. In particular, the present disclosure relates to a polypropylene copolymer composition.

### BACKGROUND OF THE INVENTION

For use in injection molded parts such as food packaging and plastic cups, the polymeric materials have certain characteristics.

In some instances, propylene-based polymers have characteristics for use in applications such as molded articles, pipes, fittings, and foams.

In some instances, polypropylene products of high stiffness are based on high molecular weight materials. In some instances, those polypropylene products are prepared by adding nucleating agents, thereby starting the crystallization of the polypropylene at a higher temperature and a higher speed.

### SUMMARY OF THE INVENTION

In a general embodiment, the present disclosure provides a polypropylene composition made from or containing:
A) from 90.6 wt % to 97.0 wt % of a propylene homopolymer, based upon the total weight of the polypropylene composition, having
   a fraction insoluble in xylene at 25° C. greater than 90 wt %, based upon the total weight of the propylene homopolymer; and
   a melt flow rate, MFR, measured according to ISO 1133-1 at 230° C. with a load of 2.16 kg between 40.0 g/10 min and 100.0 g/10 min; and
B) from 3.0 wt % to 9.4 wt % of a propylene ethylene copolymer, based upon the total weight of the polypropylene composition, having
   an ethylene derived units content ranging from 22 wt % to 38 wt %, based upon the total weight of the propylene ethylene copolymer, measured by ¹³C NMR;
wherein the polypropylene composition having:
   i) a xylene soluble fraction at 25° C. ranging from 5.0 wt % to 13.0 wt %, based upon the total weight of the polypropylene composition;
   ii) the ethylene derived units content on the fraction insoluble in xylene at 25° C. ranging from 0.3 wt % to 1.6 wt %, measured by ¹³C NMR;
   iii) the ethylene derived units content on the fraction soluble in xylene at 25° C. ranging from 13.2 wt % to 27.0 wt %, measured by ¹³C NMR; and
   (iv) a melt flow rate, MFR, measured according to ISO 1133-1 at 230° C. with a load of 2.16 kg, between 35.0 g/10 min and 70.0 g/10 min;
the sum of the amounts of A) and B) being 100 wt %.

### DETAILED DESCRIPTION OF THE INVENTION

In some embodiments, the present disclosure provides a polypropylene composition made from or containing:
A) from 90.6 wt % to 97.0 wt %; alternatively from 91.0 wt % to 96.0 wt %; alternatively from 91.0 wt % to 95 wt %; of a propylene homopolymer, based upon the total weight of the polypropylene composition, having
   a fraction insoluble in xylene at 25° C. greater than 90 wt %; alternatively greater than 94 wt %; and
   a melt flow rate, MFR, measured according to ISO 1133-1 at 230° C. with a load of 2.16 kg between 40.0 g/10 min and 100.0 g/10; alternatively between 55.0 g/10 min and 90.0 g/10 min; alternatively between 70.0 g/10 min and 85.0 g/10 min; and
B) from 3.0 wt % to 9.4 wt %; alternatively from 5.0 wt % to 9.3 wt %; alternatively from 7 wt % to 9.0 wt %; of a propylene ethylene copolymer, based upon the total weight of the polypropylene composition, having
   an ethylene derived units content, measured by ¹³C NMR; ranging from 22 wt % to 38 wt %; alternatively from 25 wt % to 35 wt %; alternatively 27 wt % to 32 wt %, based upon the total weight of the propylene ethylene copolymer;
wherein the polypropylene composition having:
   i) a xylene soluble fraction at 25° C. ranging from 5.0 wt % to 13.0 wt %; alternatively from 6.0 wt % to 12.0 wt %; alternatively from 7.0 wt % to 11.0 wt %, based upon the total weight of the polypropylene composition;
   ii) the ethylene derived units content on the fraction insoluble in xylene at 25° C. ranging from 0.3 wt % to 1.6 wt %; alternatively from 0.4 wt % to 1.5 wt %; alternatively from 0.5 wt % to 1.4 wt %, measured by ¹³C NMR;
   iii) the ethylene derived units content on the fraction soluble in xylene at 25° C. ranging from 13.2 wt % to 27.0 wt %; alternatively from 17.8 wt % to 25.2 wt %; alternatively from 18.2 wt % to 23.4 wt %, measured by ¹³C NMR; and
   iv) a melt flow rate, MFR, measured according to ISO 1133-1 at 230° C. with a load of 2.16 kg between 35.0 g/10 min and 70.0 g/10 min; alternatively between 38.0 g/10 min and 65.0 g/10 min; alternatively between 40.0 g/10 min and 60.0 g/10 min;
the sum of the amounts of A) and B) being 100 wt %.

As used herein, the term “copolymer” refers to polymers containing two kinds of comonomers, such as propylene and ethylene.

The polypropylene composition is not subjected to a chemical or physical visbreaking, that is, the MFR is obtained with the polymerization process.

In some embodiments, the polypropylene composition has an intrinsic viscosity, measured on the fraction soluble in xylene at 25° C., ranging from 0.9 to 2.3 dl/g; alternatively from 1.1 to 2.0 dl/g; alternatively from 1.2 to 1.8 dl/g.

In some embodiments, the polypropylene composition has one or more of the following properties:
a) haze, measured on 1 mm plaque, lower than 32%; alternatively lower than 31%; alternatively lower than 30%;
b) flexural modulus higher than 1300 MPa; alternatively higher than 1350 MPa; alternatively higher than 1400 MPa;
c) Charpy impact measured at 23° C. higher than 4.0 kJ/m²; alternatively higher than 4.2 kJ/m²; alternatively higher than 4.0 kJ/m²;
d) the ductile brittle transition temperature (M/B TT) lower than 11° C.; alternatively lower or equal to 10° C.; and
e) the fraction soluble in hexane measured on 100 micron film lower than 2.4%; alternatively lower than 2.3%, alternatively lower than 2.2%.

In some embodiments, the haze, measured on 1 mm plaque, has a higher value of 8%. In some embodiments, the highest value of the flexural modulus is 2500 MPa. In some embodiments, the highest value of Charpy impact, measured at 23° C., is 50 kJ/m². In some embodiments, the lowest value of the ductile brittle transition temperature (M/B TT) is 2° C. In some embodiments, the lowest value of the fraction soluble in hexane, measured on 100 micron film, is 0.5%.

In some embodiments, the polypropylene composition is obtained with a polymerization process in two or more stages wherein component A) is obtained in the first stages and then component B) is obtained in the second stages in the presence of component A). In some embodiments, each stage is in gas-phase, operating in one or more fluidized or mechanically agitated bed reactors, slurry phase using as diluent an inert hydrocarbon solvent, or bulk polymerization using the liquid monomer as a reaction medium. In some embodiments, the liquid monomer is propylene. In some embodiments, component B) is polymerized in a gas phase process in the presence of component A)

In some embodiments, the polymerization is carried out at temperature of from 20 to 120° C., alternatively of from 40 to 80° C. In some embodiments, the polymerization is carried out in gas-phase and the operating pressure is between 0.5 and 5 MPa, alternatively between 1 and 4 MPa. In some embodiments, the polymerization is carried out in bulk polymerization and the operating pressure is between 1 and 8 MPa, alternatively between 1.5 and 5 MPa. In some embodiments, hydrogen is used as a molecular weight regulator.

In some embodiments, the polypropylene composition is prepared by a process including the steps of homopolymerizing propylene in a first stage and then copolymerization propylene with ethylene in a second stage, wherein both stages are conducted in the presence of a catalyst system made from or containing the product obtained by contacting (a) a solid catalyst component (i) having average particle size ranging from 15 to 80 μm and (ii) made from or containing a magnesium halide, a titanium compound having a Ti-halogen bond, an electron donor compound such as succinates, and an electron donor compound selected from 1,3 diethers, (b) an aluminum hydrocarbyl compound, and optionally (c) an external electron donor compound.

In some embodiments, the succinate has the formula (I) below

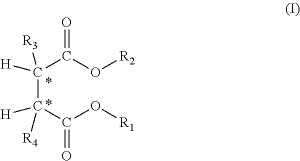

wherein the radicals R₁ and R₂, equal to or different from each other, are a C₁-C₂₀ linear or branched alkyl, alkenyl, cycloalkyl, aryl, arylalkyl, or alkylaryl group, optionally containing heteroatoms; and the radicals R₃ and R₄, equal to or different from each other, are C₁-C₂₀ alkyl, C3-C20 cycloalkyl, C5-C20 aryl, arylalkyl, or alkylaryl group, providing that R₃, R₄, or both are a branched alkyl. In some embodiments, the compounds are, with respect to the two asymmetric carbon atoms identified in the structure of formula (I), stereoisomers of the type (S,R) or (R,S)

In some embodiments, R₁ and R₂ are selected from the group consisting of C₁-C₈ alkyl, cycloalkyl, aryl, arylalkyl and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiments, R₁ and R₂ groups are selected from the group consisting of ethyl, isobutyl, and neopentyl.

In some embodiments, R₃, R₄, or both radicals are secondary alkyls or cycloalkyls. In some embodiments, the secondary alkyls are selected from the group consisting of isopropyl, sec-butyl, 2-pentyl, and 3-pentyl. In some embodiments, the cycloalkyls are selected from the group consisting of cyclohexyl, cyclopentyl, and cyclohexylmethyl.

In some embodiments, the compounds are the (S,R) (S,R) forms pure or in mixture, optionally in racemic form, of compounds selected from the group consisting of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, and diethyl 2,3-dicyclohexylsuccinate.

In some embodiments, the 1,3-diethers have formula (II)

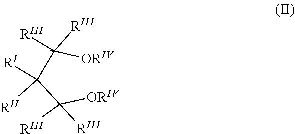

wherein R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups equal or different from each other, have the same meaning of R^{III} except that R^{IV} groups are not hydrogen. In some embodiments, R^{I} or R^{II} has constituents which form cyclic structures. In some embodiments, each of R^{I} to R^{IV} groups contains heteroatoms selected from the group consisting of halogens, N, O, S, and Si.

In some embodiments, R^{IV} is a 1-6 carbon atom alkyl radical, alternatively a methyl. In some embodiments, the R^{III} radicals are hydrogen. In some embodiments, R^{I} is selected from the group consisting of methyl, ethyl, propyl, and isopropyl while R^{II} is selected from the group consisting of ethyl, propyl, isopropyl, butyl, isobutyl, tert-butyl, isopentyl, 2-ethylhexyl, cyclopentyl, cyclohexyl, methylcyclohexyl, phenyl, and benzyl. In some embodiments, R^{I} is hydrogen while R^{II} is selected from the group consisting of ethyl, butyl, sec-butyl, tert-butyl, 2-ethylhexyl, cyclohexylethyl, diphenylmethyl, p-chlorophenyl, 1-naphthyl, and 1-decahydronaphthyl. In some embodiments, R^{I} and R^{II} are the same and selected from the group consisting of ethyl, propyl, isopropyl, butyl, isobutyl, tert-butyl, neopentyl, phenyl, benzyl, cyclohexyl, and cyclopentyl.

In some embodiments, the 1,3-diethers are selected from the group consisting of 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2(1-naphthyl)-1,3-dimethoxypropane, 2(p-fluorophenyl)-1,3-dimethoxypropane, 2(1-decahydronaphthyl)-1,3-dimethoxypropane, 2(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane,2,2-bis(p-methylphenyl)-1,3-dimethoxypropane, 2-methyl-2-isopropyl-1,3-dimethoxypropane,2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-iso-propyl-2-isopentyl-1,3-dimethoxypropane, 2-phenyl-2-benzyl-1,3-dimetoxypropane, and 2-cyclohexyl-2-cyclohexylmethyl-1,3-dimethoxypropane.

In some embodiments, the 1,3-diethers have formula (III)

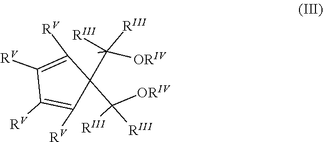

wherein the radicals R^{IV} have the same meaning defined in formula (II) and the radicals R^{III} and R^{V} radicals, equal or different to each other, are selected from the group consisting of hydrogen; halogens; C₁-C₂₀ alkyl radicals, linear or branched; C₃-C₂₀ cycloalkyl, C₆-C₂₀ aryl, C₇-C₂₀ alkaryl, and C₇-C₂₀ aralkyl radicals. In some embodiments, two or more of the R^{V} radicals are bonded to each other to form condensed cyclic structures, saturated or unsaturated, optionally substituted with R^{VI} radicals. In some embodiments, R^{VI} radicals are selected from the group consisting of halogens; C₁-C₂₀ alkyl radicals, linear or branched; C₃-C₂₀ cycloalkyl, C₆-C₂₀ aryl, C₇-C₂₀ alkylaryl and C₇-C₂₀ arylalkyl radicals. In some embodiments, the halogens are selected from the group consisting of Cl and F. In some embodiments, the radicals R^{V} and R^{VI} contain one or more heteroatoms as substitutes for carbon or hydrogen atoms, or both.

In some embodiments and in the 1,3-diethers of formulae (I) and (II), the R^{III} radicals are hydrogen, and the R^{IV} radicals are methyl. In some embodiments, the 1,3-diethers of formula (II) have two or more of the R^{V} radicals bonded to each other, thereby forming one or more condensed cyclic structures, optionally substituted by R^{VI} radicals. In some embodiments, the condensed cyclic structures are benzenic. In some embodiments, the 1,3-diethers have formula (IV):

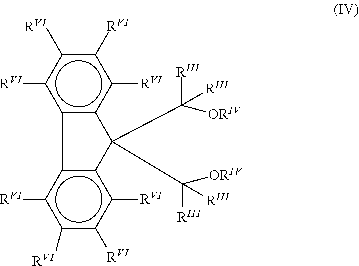

wherein the R^{VI} radicals equal or different are hydrogen; halogens; C₁-C20 alkyl radicals, linear or branched; C₃-C₂₀ cycloalkyl, C₆-C₂₀ aryl, C₇-C₂₀ alkylaryl and C₇-C₂₀ aralkyl radicals, optionally containing one or more heteroatoms selected from the group consisting of N, O, S, P, Si, and halogens, as substitutes for carbon or hydrogen atoms, or both; the radicals R^{III} and R^{IV} are as defined above for formula (III). In some embodiments, the halogens are selected from the group consisting of Cl and F.

In some embodiments, the 1,3-diethers of formulae (III) and (IV) are selected from the group consisting of:
1,1-bis(methoxymethyl)-cyclopentadiene;
1,1-bis(methoxymethyl)-2,3,4,5-tetramethylcyclopentadiene;
1,1-bis(methoxymethyl)-2,3,4,5-tetraphenylcyclopentadiene;
1,1-bis(methoxymethyl)-2,3,4,5-tetrafluorocyclopentadiene;
1,1-bis(methoxymethyl)-3,4-dicyclopentylcyclopentadiene;
1,1--bis(methoxymethyl) indene; 1,1-bis(methoxymethyl)-2,3-dimethylindene;
1,1-bis(methoxymethyl)-4,5,6,7-tetrahydroindene;
1,1-bis(methoxymethyl)-2,3,6,7-tetrafluoroindene;
1,1-bis(methoxymethyl)-4,7-dimethylindene;
1,1-bis(methoxymethyl)-3,6-dimethylindene;
1,1-bis(methoxymethyl)-4-phenylindene;
1,1-bis(methoxymethyl)-4-phenyl-2-methylindene;
1,1-bis(methoxymethyl)-4-cyclohexylindene;
1,1-bis(methoxymethyl)-7-(3,3,3-trifluoropropyl) indene;
1,1-bis(methoxymethyl)-7-trimethyisilylindene;
1,1-bis(methoxymethyl)-7-trifluoromethylindene;
1,1-bis(methoxymethyl)-4,7-dimethyl-4,5,6,7-tetrahydroindene;
1,1-bis(methoxymethyl)-7-methylindene;
1,1-bis(methoxymethyl)-7-cyclopenthylindene;
1,1-bis(methoxymethyl)-7-isopropylindene;
1,1-bis(methoxymethyl)-7-cyclohexylindene;
1,1-bis(methoxymethyl)-7-tert-butylindene;
1,1-bis(methoxymethyl)-7-tert-butyl-2-methylindene;
1,1-bis(methoxymethyl)-7-phenylindene;
1,1-bis(methoxymethyl)-2-phenylindene;
1,1-bis(methoxymethyl)-1H-benz[e] indene;
1,1-bis(methoxymethyl)-1H-2-methylbenz[e] indene;
9,9-bis(methoxymethyl) fluorene;
9,9-bis(methoxymethyl)-2,3,6,7-tetramethylfluorene;
9,9-bis(methoxymethyl)-2,3,4,5,6,7-hexafluorofluorene;
9,9-bis(methoxymethyl)-2,3-benzofluorene;
9,9-bis(methoxymethyl)-2,3,6,7-dibenzofluorene;
9,9-bis(methoxymethyl)-2,7-diisopropylfluorene;
9,9-bis(methoxymethyl)-1,8-dichlorofluorene;
9,9-bis(methoxymethyl)-2,7-dicyclopentylfluorene;
9,9-bis(methoxymethyl)-1,8-difluorofluorene;
9,9-bis(methoxymethyl)-1,2,3,4-tetrahydrofluorene;
9,9-bis(methoxymethyl)-1,2,3,4,5,6,7,8-octahydrofluorene; and
9,9-bis(methoxymethyl)-4-tert-butylfluorene.

In some embodiments, the catalyst component (a) is made from or containing internal electron donors, a titanium compound having a Ti-halogen bond, and an Mg halide. In some embodiments, the magnesium halide is MgCl₂ in active form.

In some embodiments, the titanium compounds are selected from the group consisting of TiCl₄ and TiCl₃. In some embodiments, the titanium compounds are Ti-haloalcoholates having formula Ti(OR)_{n-y}X_{y}, where n is the valence of titanium, y is a number between 1 and n-1, X is halogen, and R is a hydrocarbon radical having from 1 to 10 carbon atoms.

In some embodiments, the catalyst component (a) has an average particle size ranging from 20 to 70 μm, alternatively from 25 to 65 μm. In some embodiments, the succinate is present in an amount ranging from 50 to 90% by weight with respect to the total amount of donors. In some embodiments, the amount of succinate ranges from 60 to 85% by weight, alternatively from 65 to 80% by weight. In some embodiments, the 1,3-diether constitutes the remaining amount.

In some embodiments, aluminum hydrocarbyl compound (b) is an aluminum hydrocarbyl compound, wherein the hydrocarbyl is selected from C₃-C₁₀ branched aliphatic or aromatic radicals. In some embodiments, the hydrocarbyl is a branched aliphatic radical, alternatively selected from branched trialkyl aluminum compounds. In some embodiments, the branched trialkyl aluminum compounds are selected from the group consisting of triisopropylaluminum, tri-iso-butylaluminum, tri-iso-hexylaluminum, and tri-iso-octylaluminum. In some embodiments, mixtures of branched trialkylaluminums are used with alkylaluminum halides, alkylaluminum hydrides, or alkylaluminum sesquichlorides. In some embodiments, alkylaluminum sesquichlorides are selected from the group consisting of AlEt₂Cl and Al₂Et₃Cl₃.

In some embodiments, external electron-donor compounds are selected from the group consisting of silicon compounds, ethers, esters, amines, heterocyclic compounds, ketones, and the 1,3-diethers. In some embodiments, the ester is ethyl 4-ethoxybenzoate. In some embodiments, the heterocyclic compound is 2,2,6,6-tetramethyl piperidine. In some embodiments, the silicon compounds have formula Rₐ⁵R_{b}⁶Si(OR⁷)_{c}, wherein a and b are integers from 0 to 2, c is an integer from 1 to 3, and the sum (a+b+c) is 4; R⁵, R⁶, and R⁷ are alkyl, cycloalkyl, or aryl radicals with 1-18 carbon atoms optionally containing heteroatoms. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1,trifluoropropyl-methyl-dimethoxysilane. In some embodiments, the amount of external electron donor compound provides a molar ratio between the aluminum hydrocarbyl compound and the electron donor compound of from 5 to 500, alternatively from 5 to 400, alternatively from 10 to 200.

In some embodiments, the catalyst forming components are contacted with a liquid inert hydrocarbon solvent, at a temperature below about 60° C., alternatively from about 0 to 30° C., for a time period of from about six seconds to 60 minutes. In some embodiments, the liquid inert hydrocarbon solvent is propane, n-hexane, or n-heptane.

In some embodiments, the catalyst components (a), (b), and optionally (c) are fed to a pre-contacting vessel, in amounts such that the weight ratio (b)/(a) is in the range of 0.1-10. In some embodiments, compound (c) is present, and the weight ratio (b)/(c) is weight ratio of from 5 to 500, alternatively from 5 to 400, alternatively from 10 to 200. In some embodiments, the components are pre-contacted at a temperature of from 10 to 20° C., for 1-30 minutes. In some embodiments, the precontact vessel is a stirred tank or a loop reactor.

In some embodiments, the present disclosure provides an injection molded article made from or containing the polypropylene composition.

In some embodiments, the polypropylene composition is further made from or containing additives. In some embodiments, the additives are selected from the group consisting of anti-oxidants, process stabilizers, slip agents, antistatic agents, antiblock agents, antifog agents, and nucleating agents.

The following examples are given to illustrate, not to limit, the present disclosure:

### EXAMPLES

### Xylene-Soluble (XS) Fraction at 25° C.

Xylene Solubles at 25° C. were determined according to ISO 16 152; with solution volume of 250 ml, precipitation at 25° C. for 20 minutes, 10 minutes of which with the solution in agitation (magnetic stirrer), and drying at 70° C.

### Melt Flow Rate (MFR)

Measured according to ISO 1133-1 at 230° C. with a load of 2.16 kg, unless otherwise specified.

### Intrinsic Viscosity (IV)

The sample was dissolved in tetrahydronaphthalene at 135° C. and then poured into a capillary viscometer. The viscometer tube (Ubbelohde type) was surrounded by a cylindrical glass jacket. This setup allowed for temperature control with a circulating thermostatic liquid. The downward passage of the meniscus was timed by a photoelectric device.

The passage of the meniscus in front of the upper lamp started the counter, which had a quartz crystal oscillator. The counter stopped as the meniscus passed the lower lamp. The efflux time was registered and converted into a value of intrinsic viscosity through Huggins' equation (Huggins, M. L., J. Am. Chem. Soc., 1942, 64, 2716), using the flow time of the pure solvent at the same experimental conditions (same viscometer and same temperature). A single polymer solution was used to determine [η].

### Determination of the Haze

Injection molded specimens, prepared according to ISO 1873-2, and ISO 294, were used. The haze value was measured using a Gardner photometric unit connected to a Hazemeter type UX-10 or an equivalent instrument having G.E. 1209 light source with filter “C”. Standard samples were used for calibrating the instrument.

### Flexural Modulus

Determined according to ISO 178 and supplemental condition according to ISO 1873-2 with specimen injection molded.

### Ethylene Content in the Copolymers

¹³C NMR spectra were acquired on a Bruker AV-600 spectrometer equipped with cryoprobe, operating at 160.91 MHz in the Fourier transform mode at 120° C.

The peak of the Sββ carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H—¹³C coupling. 512 transients were stored in 32K data points using a spectral window of 9000 Hz.

The assignments of the spectra, the evaluation of triad distribution, and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:
PPP=100 Tββ/S PPE=100 Tβδ/S EPE=100 Tδδ/S
PEP=100 Sββ/S PEE=100 Sβδ/S EEE=100 (0.25 Sγδ+0.5 Sδδ)/S

S=Tββ+Tβδ+Tδδ+Sββ+Sβδ+0.25 Sγδ+0.5 Sδδ

The molar percentage of ethylene content was evaluated using the following equation:

E% mol=100*[PEP+PEE+EEE]

The weight percentage of ethylene content was evaluated using the following equation:

E% mol*MWE

E% wt.=E% mol*MWE+P% mol*MWP
where P% mol is the molar percentage of propylene content, while MWE and MWP are the molecular weights of ethylene and propylene, respectively.

The product of reactivity ratio rlr2 was calculated according to Carman (C. J. Carman, R. A. Harrington and C. E. Wilkes, Macromolecules, 1977; 10, 536) as:

$$\\ {r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

### Charpy Impact Test

Charpy impact test was measured according to ISO 179-1eA, e ISO 1873-2.

### Tensile Modulus

Tensile Modulus was measured according to ISO 527-2, and ISO 1873-2 on injection molded sample.

### Hexane Extractable on 100 μm Film

Hexane extractable was determined according to FDA 177, 1520 by suspending, in an excess of hexane, a specimen. The film was prepared by extrusion. The suspension was in an autoclave at 50° C. for 2 hours, then the hexane was removed by evaporation. The dried residue was weighed.

### Ductile Brittle Transition Temperature by DSC

The ductile brittle transition temperature was measured according to ISO 11357-3, at scanning rate of 20 C/min both in cooling and heating, on a sample having a weight between 5 and 7 mg., under inert N2 flow. The instrument was calibrated with Indium.

### Determination of Mg, Ti

The determination of Mg and Ti content in the solid catalyst component was carried out via inductively coupled plasma emission spectroscopy on “I.C.P Spectrometer ARL Accuris”.

The sample was prepared by analytically weighing, in a “Fluxy” platinum crucible ”, 0.1÷0.3 grams of catalyst and 2 grams of lithium metaborate/tetraborate 1/1 mixture. After addition of some drops of KI solution, the crucible was inserted in a “Claisse Fluxy” for the complete burning. The residue was collected with a 5% v/v HNO₃ solution and then analyzed via ICP at the following wavelengths: Magnesium, 279.08 nm; Titanium, 368.52 nm.

### Determination of Bi

The determination of Bi content in the solid catalyst component was carried out via inductively coupled plasma emission spectroscopy on “I.C.P Spectrometer ARL Accuris”.

The sample was prepared by analytically weighing in a 200 cm³ volumetric flask 0.1÷0.3 grams of catalyst. After slow addition of both about 10 milliliters of 65% v/v HNO₃ solution and about 50 cm³ of distilled water, the sample underwent a digestion for 4÷6 hours. Then the volumetric flask was diluted to the mark with deionized water. The resulting solution was directly analyzed via ICP at the following wavelength: Bismuth, 223.06 nm.

### Determination of Internal Donor Content

The determination of the content of internal donor in the solid catalytic compound was done through gas chromatography. The solid component was dissolved in acetone, an internal standard was added, and a sample of the organic phase was analyzed in a gas chromatograph, thereby determining the amount of donor present at the starting catalyst compound.

### Examples 1

### Preparation of the Ziegler-Natta Solid Catalyst

### Preparation of the Solid Catalyst Component

Into a 500 mL four-necked round flask, purged with nitrogen, 250 mL of TiCl₄ were introduced at 0° C. While stirring, 10.0 g of microspheroidal MgCl₂·2.5C₂H₅OH, having an average particle size of 47μm, (prepared by thermally dealcoholating a starting adduct obtained according to the procedure of example 1 of Patent Cooperation Treaty Publication No. WO2012/084735) and an amount of diethyl 2,3-diisopropylsuccinate in racemic form, to provide a Mg/succinate molar ratio of 12 were added. The temperature was raised to 100° C. and maintained for 60 min. After siphoning, fresh TiCl₄ and an amount of 9,9-bis(methoxymethyl)fluorine (bMMF), thereby providing a Mg/(bMMF) molar ratio of 12, were added. The temperature was raised to 90° C. and maintained for 30 min. After siphoning, the treatment with TiCl₄ was repeated at 90° C. for 30 min. The solid was washed six times with anhydrous hexane (6×100 ml) at 60° C. and finally dried.

### Prepolymerization Treatment

The solid catalyst component was contacted with triethyl aluminum (TEAL), in the absence of external electron donors. The mixture was subjected to prepolymerization by suspending the mixture in liquid propylene at 20° C. for about 5 minutes, before introducing the suspension into the polymerization reactor.

### Polymerization

The polymerization of component A) was carried out continuously in a series of two reactors equipped with devices to transfer the product from the first reactor to the second reactor. The polymerization was carried out in gas-phase polymerization reactor having two interconnected polymerization zones, a riser and a downcomer. No “barrier stream” was used.

The polymer (A) coming from the first reactor was discharged in a continuous flow. After the polymer (A) was purged of unreacted monomers, the polymer (A) was introduced, in a continuous flow, into the second stirred bed gas phase reactor. In the second reactor, a copolymer of ethylene (B) was produced.

Quantities of monomers and hydrogen fed to the polymerization reactor are reported in Table 1.

TABLE 1

| | | | 1 | Comp 2 | 2 |
|---|---|---|---|---|---|
| | Example | | box 18 | box 23 | box 31 |
| PRECONTACT | | | | | |
| | Temperature | ° C. | 15 | 15 | 15 |
| | Residence Time | min | 15 | 15 | 15 |
| | TEAL/catalyst | wt/wt | 5 | 5 | 5 |
| | TEAL/Ext. Donor | g/g | 8 | 9 | 10 |
| PREPOLYMERIZATION | | | | | |
| | Temperature | ° C. | 20 | 20 | 20 |
| | Residence Time | min | 8 | 8 | 8 |
| | Split | Wt % | 92.0 | 89.8 | 91.0 |
| POLYMERIZATION | | | | | |
| Gas loop | | | | | |
| | Temperature | bar-g | 66 | 66 | 66 |
| | Pressure | bar-g | 27 | 27 | 27 |
| | Residence Time | min | 95 | 95 | 95 |
| | H₂/C₃ riser | mol/mol | 0.038 | 0.038 | 0..038 |
| | Gas phase reactor | | | | |
| | H₂/C2⁻⁻ | mol/mol | 0.205 | 0.2015 | 0.205 |
| | C2/C2 + C3 | mol/mol | 0.097 | 0.103 | 0.095 |
| | Split | Wt % | 8.0 | 10.2 | 9.0 |

C3 propylene,
C2 ethylene H2 hydrogen

The polymer of examples 1 and 3 and comparative example 2 have been characterized as reported in Table 2.

TABLE 2

| | | | Comp | |
|---|---|---|---|---|
| | | Ex 1 | ex 2 | Ex3 |
| Component A | | | | |
| MFR | g/10 min | 72 | 81 | 78 |
| Xs | Wt % | 2.1 | 2.1 | 2.1 |
| split | Wt % | 92.0 | 89.8 | 91.0 |
| Component B | | | | |
| split | Wt % | 8.0 | 10.2 | 9.0 |
| Ethylene content | Wt % | 31.4 | 29.5 | 29.6 |
| Total composition | | | | |
| XS | Wt % | 9.0 | 10.9 | 9.7 |
| Intrinsic viscosity xylene | dl/g | 1.53 | 1.47 | 1.39 |
| solubles 25° C. | | | | |
| Ethylene in the fraction | Wt % | 0.7 | 1.0 | 0.8 |
| insoluble in xylene at 25° C. | | | | |
| Ethylene in the fraction | Wt % | 21.6 | 19.9 | 20.6 |
| soluble in xylene at 25° C. | | | | |
| Characterization | | | | |
| Tens mod | MPa | 1560 | 1417 | 1420 |
| Charpy 23° C. | Kj/m² | 4.4 | 4.7 | 4.6 |
| Haze | % | 28.8 | 34.7 | 28.6 |
| M/B TT | ° C. | >10 | 12.0 | 7.1 |
| hexane extractable | wt % | 2.0 | 2.4 | 2.1 |

1. A polypropylene composition comprising:
A) from 90.6 wt % to 97.0 wt % of a propylene homopolymer, based upon the total weight of the polypropylene composition, having
a fraction insoluble in xylene at 25° C. greater than 90 wt %, based upon the total weight of the propylene homopolymer; and
a melt flow rate, MFR, measured according to ISO 1133-1 at 230° C. with a load of 2.16 kg between 40.0 g/10 min and 100.0 g/10 min; and
B) from 3.0 wt % to 9.4 wt % of a propylene ethylene copolymer, based upon the total weight of the polypropylene composition, having
an ethylene derived units content ranging from 22 wt % to 38 wt %, based upon the total weight of the propylene ethylene copolymer, measured by ¹³C NMR;
wherein the polypropylene composition having:
i) a xylene soluble fraction at 25° C. ranging from 5.0 wt % to 13.0 wt %, based upon the total weight of the polypropylene composition;
ii) the ethylene derived units content on the fraction insoluble in xylene at 25° C. ranging from 0.3 wt % to 1.6 wt %, measured by ¹³C NMR;
iii) the ethylene derived units content on the fraction soluble in xylene at 25° C. ranging from 13.2 wt % to 27.0 wt %, measured by ¹³C NMR; and
(iv) a melt flow rate, MFR, measured according to ISO 1133-1 at 230° C. with a load of 2.16 kg, between 35.0 g/10 min and 70.0 g/10 min;
the sum of the amounts of A) and B) being 100 wt %.

2. The polypropylene composition according to claim 1, wherein the polypropylene composition comprises from 91.0 wt % to 96.0 wt % of component A) and from 5.0 wt % to 9.3 wt % of component B).

3. The polypropylene composition according to claim 1, wherein the xylene soluble fraction at 25° C. ranges from 6.0 wt % to 12.0 wt %.

4. The polypropylene composition according to claim 1, wherein component A) has a melt flow rate, MFR, measured according to ISO 1133-1 at 230° C. with a load of 2.16 kg between 55.0 g/10 min and 90.0 g/10 min.

5. The polypropylene composition according to claim 1, wherein the polypropylene composition has an intrinsic viscosity, measured on the fraction soluble in xylene at 25° C., ranging from 0.9 to 2.3 dl/g

6. The polypropylene composition according to claim 1, wherein the ethylene derived units content on the fraction insoluble in xylene at 25° C. ranges from 0.4 wt % to 1.5 wt %.

7. The polypropylene composition according to claim 1, wherein the ethylene derived units content on the fraction soluble in xylene at 25° C. ranges from 17.8 wt % to 25.2 wt %.

8. The polypropylene composition according to claim 1, wherein the polypropylene composition has an intrinsic viscosity, measured on the fraction soluble in xylene at 25° C., ranging from 1.1 to 2.0 dl/g.

9. The polypropylene composition according to claim 1, wherein the polypropylene composition has a melt flow rate, MFR, measured according to ISO 1133-1 at 230° C. with a load of 2.16 kg, between 38.0 g/10 min and 65.0 g/10 min.

10. The polypropylene composition according to claim 1, wherein the polypropylene composition comprises from 91.0 wt % to 95 wt % of component A) and from 7 wt % to 9.0 wt % of component B).

11. The polypropylene composition according claim 1, wherein the xylene soluble fraction at 25° C. ranges from 7 wt % to 11 wt %.

12. The polypropylene composition according to claim 1, wherein the polypropylene composition has a melt flow rate, MFR, measured according to ISO 1133-1 at 230° C. with a load of 2.16 kg, between 40.0 g/10 min and 60.0 g/10 min.

13. The polypropylene composition according to claim 1, wherein component A) has a melt flow rate, MFR, measured according to ISO 1133-1 at 230° C. with a load of 2.16 kg, between −70.0 g/10 min and 85.0 g/10 min.

14. The polypropylene composition according to claim 1, wherein the polypropylene composition has an intrinsic viscosity measured on the fraction soluble in xylene at 25° C. ranges from 1.2 to 1.8 dl/g.

15. An injection molded article comprising the polypropylene composition of claim l.
